(19) United States
(12) Patent Application Publication
(10) Pub. No.: US 2020/0143549 A1
(43) Pub. Date: May 7, 2020

(54) IMAGE PROCESSING METHOD AND DEVICE, AND UNMANNED AERIAL VEHICLE

(71) Applicant: SZ DJI TECHNOLOGY CO., LTD., Shenzhen (CN)

(72) Inventors: Chao WENG, Shenzhen (CN); Mingxi WANG, Shenzhen (CN); Jie FAN, Shenzhen (CN)

(21) Appl. No.: 16/728,288

(22) Filed: Dec. 27, 2019

Related U.S. Application Data
(63) Continuation of application No. PCT/CN2017/108757, filed on Oct. 31, 2017.

(51) Int. Cl. G06T 7/33; G06T 7/13; G06T 3/40

(52) U.S. Cl. CPC G06T 7/33; G06T 7/13; G06T 2207/10048; G06T 2207/20221; G06T 3/4038

(57) ABSTRACT

An image processing method includes obtaining first contour information of a first image captured by a first lens and second contour information of a second image captured by a second lens, the first and second images being captured at the same time, aligning the first contour information of the first image with the second contour information of the second image to obtain aligning contour information of the first and second contour information, and adjusting a relative position between the first and second images according to the aligning contour information to fuse the first and second images to obtain a fused image, the fused image including first edge information of the first image and second edge information of the second image.

### CROSS-REFERENCE TO RELATED APPLICATION

This application is a continuation of International Application No. PCT/CN2017/108757, filed Oct. 31, 2017, the entire content of which is incorporated herein by reference.

### TECHNICAL FIELD

The present disclosure is directed to technical area of unmanned aerial vehicle, and in particular to an image processing method and device, and unmanned aerial vehicle incorporating the same.

### BACKGROUND

Image information or video information on a target object captured via thermal imaging includes temperature information of the target object; however, such thermal images do not present clear edges.

Some technologies extract feature points from the thermal images and the visible light images, feature points to be used for image matched are selected further via similarity assessment, matching is performed between the selected feature points, spatial coordinate transformation parameters between the selected feature points are determined, and matching between the thermal images and the visible light images are then performed according to the spatial coordinate transformation parameters.

In these existing technologies, extracting feature points from the thermal images and the visible images is prone to human errors associated with feature extraction, matching between the thermal images and the visible light images may be rendered inadequate and resulting matched image is often of unacceptable quality.

### SUMMARY

In accordance with the present disclosure, there is provided an image processing method including obtaining first contour information of a first image captured by a first lens and second contour information of a second image captured by a second lens, the first and second images being captured at the same time, aligning the first contour information of the first image with the second contour information of the second image to obtain aligning contour information of the first and second contour information, and adjusting a relative position between the first and second images according to the aligning contour information to fuse the first and second images to obtain a fused image, the fused image including first edge information of the first image and second edge information of the second image.

In accordance with the present disclosure, there is also provided an image processing device including a processor configured to perform obtaining first contour information of a first image captured by a first lens and second contour information of a second image captured by a second lens, the first and second images being captured at the same time, aligning the first contour information of the first image with the second contour information of the second image to obtain aligning contour information of the first and second contour information, and adjusting a relative position between the first and second images according to the aligning contour information to fuse the first and second images to obtain a fused image, the fused image including first edge information of the first image and second edge information of the second image.

In accordance with the present disclosure, there is also provided an imaging device including first and second lens, and an image processing device, where the image processing device includes a processor, the processor being configured to perform obtaining first contour information of a first image captured by the first lens and second contour information of a second image captured by the second lens, the first and second images being captured at the same time, aligning the first contour information of the first image with the second contour information of the second image to obtain aligning contour information of the first and second contour information, and adjusting a relative position between the first and second images according to the aligning contour information to fuse the first and second images to obtain a fused image, the fused image including first edge information of the first image and second edge information of the second image.

### BRIEF DESCRIPTION OF THE DRAWINGS

Objectives, features, and advantages of the embodiments are more readily understandable in reference to the accompanying drawings described below. In the accompanying drawings, the embodiments are described without limiting the scope of the present disclosure.

FIG. 1 is a schematic flow chart diagram of an image processing method according to an embodiment of the present disclosure.

FIG. 2 is a schematic flow chart diagram of an image processing method according to another embodiment of the present disclosure.

FIG. 3 is a schematic diagram of an edge image corresponding to a thermal image according to yet another embodiment of the present disclosure.

FIG. 4 is a schematic diagram of an outer contour of a thermal image according to yet another embodiment of the present disclosure.

FIG. 5 is a schematic flow chart diagram of an image processing method according to yet another embodiment of the present disclosure.

FIG. 6 is a schematic diagram of a shaded image corresponding to a thermal image according to yet another embodiment of the present disclosure.

FIG. 7 is a schematic diagram of an edge image corresponding to a thermal image according to yet another embodiment of the present disclosure.

FIG. 8 is a schematic diagram of an outer contour corresponding to a thermal image according to yet another embodiment of the present disclosure.

FIG. 9 is a schematic diagram of an outer contour corresponding to a visible light image according to yet another embodiment of the present disclosure.

FIG. 10 is a schematic flow chart diagram of an image processing method according to yet another embodiment of the present disclosure.

FIG. 11 is a schematic diagram of an outer contour corresponding to a thermal image according to yet another embodiment of the present disclosure.

FIG. 12 is a schematic flow chart diagram of an image processing method according to yet another embodiment of the present disclosure.

FIG. 13 is a schematic structure diagram of an image processing device according to yet another embodiment of the present disclosure.

FIG. 14 is a schematic structure diagram of an imaging device according to yet another embodiment of the present disclosure.

FIG. 15 is a schematic structure diagram of a ground station device according to yet another embodiment of the present disclosure.

FIG. 16 is a schematic structure diagram of an unmanned aerial vehicle according to yet another embodiment of the present disclosure.

FIG. 17 is a schematic structure diagram of an unmanned aerial vehicle according to yet another embodiment of the present disclosure.

### DETAILED DESCRIPTION OF THE EMBODIMENTS

FIG. 1 is a schematic flow chart diagram of an image processing method according to one embodiment of the present disclosure, which may include the following step(s).

At steps S101, first contour information is obtained of the first image captured by the first lens, second contour information is obtained of the second image captured by the second lens, the first and second images being captured at the same time.

An image processing device may perform the imaging process method described herein, where the image processing device may be positioned onto an imaging device, for example, an imaging device to be held by a user, or an image device positioned to a hand-held gimbal. The imaging device includes first and second lenses. The first lens is employed to capture the first image, the second lens is employed to capture the second image, and the first and second images being captured at the same time. The image processing device performs image processing on the first image to obtain the first edge information of the first image and performs image processing on the second image to obtain the second edge information of the second image.

The image processing device may be positioned onto an unmanned aerial vehicle, for example, an unmanned aerial vehicle configured with an imaging device, in which the image processing device may process images captured by the imaging device positioned on the unmanned aerial vehicle. In some embodiments, the imaging device includes first and second lenses. The first lens captures the first image, the second lens captures the second image, and the first and second images are captured at the same time. Image processing device performs image processing on the first image to obtain the first contour image of the first image and performs image processing on the second image to obtain the second contour image of the second image.

The image processing device may be configured onto a ground station device corresponding to an unmanned aerial vehicle, where the ground station device may be a remote controller, a smart phone, a tablet computer, a ground control station, a laptop computer, a watch, a wristband, or any combinations thereof. The ground station device receives image data sent by the unmanned aerial vehicle, and the image processing device of the ground station device process the image data sent by the unmanned aerial vehicle.

In some embodiments, the step of obtaining the first contour information of the first image captured by the first lens and obtaining the second contour information of the second image captured by the second lens includes: receiving the first image captured by the first lens and the second image captured by the second lens, the first and second images being sent by the unmanned aerial vehicle, the first and second lens being positioned on the unmanned aerial vehicle; and obtaining the first contour information according to the first image and obtaining the second contour information according to the second image. For example, the imaging device on the unmanned aerial vehicle includes first and second lens, where the first lens captures the first image, the second lens captures the second image, and the first and second images are captured at the same time. The unmanned aerial vehicle sends the first and second images to the ground station device via communication system, the image processing device of the ground station processes the first image to obtain the first contour information and processes the second image to obtain the second contour information.

In some embodiments, the first lens includes a thermal imaging lens, the second lens includes a visible light lens. The first image captured by the first lens includes a thermal image. The second image captured by the second lens includes a visible light image.

In some embodiments, a field of view of the second lens covers over or overlays a field of view of the first lens. For example, a field of view of the visible light lens covers over or overlays a field of view of the thermal imaging lens.

In some embodiments, a focal length of the second lens is smaller than a focal length of the first lens. For example, a focal length of the visible light lens is smaller than a focal length of the thermal imaging lens, such that the field of view of the visible lens covers over or overlays the field of view of the thermal imaging lens.

In some embodiments, the first and second lens are configured onto the imaging device via a lens carrier, where the lens carrier may be a panel.

Several suitable methods may be employed to install the first and second lenses on to the lens carrier.

The second lens may be connected to the lens carrier, the first lens is connected to the lens carrier via a flexible component. For example, the visible light lens may be connected to a main panel, and the thermal imaging lens may be connected to the main panel via a flexible component such as a spring.

Alternatively, the first lens may be connected to the lens carrier, the second lens is connected to the lens carrier via a flexible component. For example, the thermal imaging lens may be connected to a main panel, and the visible light lens may be connected to the main panel via a flexible component such as a spring.

The first and second lenses may each be connected to the lens carrier via a flexible component. For example, the thermal imaging lens and the visible light lens may each be connected to the lens carrier via a flexible component such as a spring fixed onto a panel.

In some embodiments, and via adjusting the flexible component, a center of the first lens and a center of the second lens may be positioned on a same horizontal line. In other words, and via adjusting the flexible component, a relative position between the visible light lens and the thermal imaging lens may be adjusted, to position the center of the first lens and the center of the second lens on the same horizontal line.

The first lens is not present in the field of view of the second lens, and the second lens is not present in the field of view of the first lens. A distance between the visible light lens and the thermal imaging lens may be suitably adjusted, such that the visible light lens is not present in the field of view of the thermal imaging lens, and the thermal lens is not present in the field of view of the visible light lens, or that the visible light lens and the thermal imaging lens do not interfere with each other. The distance between the visible light lens and the thermal imaging lens may be determined according to a field of view and a length of the visible light lens, and according to a field of view and a length of the thermal imaging lens.

At step S102, alignment is performed between the first contour information of the first image and the second contour information of the second image, to obtain aligning contour information between the first and second images.

The first and second images are captured at the same time. For example, the thermal image and the visible light image are captured at the same time; therefore, the thermal image and the visible light image are different images of the same object. Contours of the thermal image and the visible light image on the same object are of certain similarity to each other; therefore, alignment may be performed between the contours of the thermal image and the visible light image to obtain aligning contour information showing relatively greater similarity between the thermal image and the visible light image.

At step S103, and according to aligning contour information between the first and second images, a relative position between the first and second images is adjusted to obtain a fused image between the first and second images, the fused image including edge formation of the first and second images.

According to the aligning contour information with relatively greater similarity between the thermal image and the visible light image, a relative position between the thermal image and visible light image may be adjusted to effectuate alignment between the images, and a fused image may be obtained between the thermal image and the visible light image. As a result of image fusion, edge information of the visible light image may be overlaid onto the thermal image.

The first and second images are fused to form a fused image, the fused image including edge information of the first and second images; in particular, and according to a strength value of the edge information represented by a predetermined parameter, the edge information of the second image is overlaid onto the first image to obtain the fused image.

When fusing the thermal image and the visible light image, the image processing device may overlay the edge information of the visible light of certain strength onto the thermal image, according to a predetermined parameter representing the strength of the edge information. In other words, the strength of the edge information of the visible light image may be adjusted, via any suitable methods per user preference. In some embodiments, the bigger the predetermined parameter on the strength, more prominent the edge information of the visible light image overlaid onto the thermal image; conversely, the smaller the predetermined parameter on the strength, less prominent the edge information of the visible light image overlaid onto the thermal image.

The first contour information is obtained from the first image captured by the first lens, the second contour information is obtained from the second image captured by the second image, the first and second images are captured at the same time, the first contour information of the first image is aligned with the second contour information of the second image to obtain aligning contour information between the first and second images. Via adjusting a relative position between the first and second images according to the aligning contour information, the first image is fused with the second image to obtain a fused image. In so doing, the fused image may be created without necessarily having to extract characteristic features of the first and second images, and therefore quality problems otherwise associated with feature extractions may be avoided.

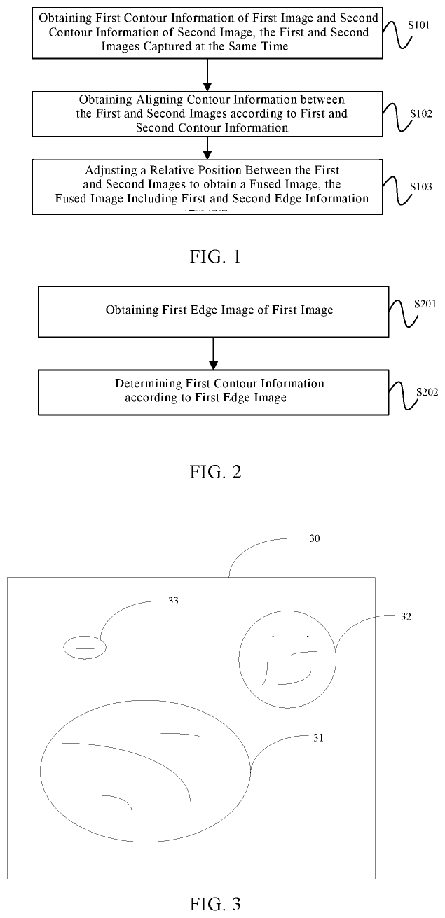

The present disclosure provides an image processing method. FIG. 2 is a schematic flow chart diagram of an image processing method. As illustratively depicted in FIG. 2, and in view of FIG. 1, step S101 refers to obtaining first contour information of the first image captured by the first lens.

At step S201, image processing is performed on the first image captured by the first lens to obtain the first edge image of the first image. As detailed herein below, and in some embodiments, the first edge image is obtained by morphological processing on an edge-extracted image of the first image, where the edge-extracted image is previously obtained via performing edge extraction on the first image.

In this embodiment, the first lens includes a thermal imaging lens, the first image captured by the first lens is a thermal image, and the image processing device performs image processing on the thermal image to obtain the edge image corresponding to the thermal image.

Several methods may be used to perform image processing on the first image captured by the first lens to obtain the edge image corresponding first image.

Edge extraction is performed on the first image captured by the first lens to obtain the first edge image of the first image. For example, the image processing device performs edge extraction on the thermal image to obtain edge image corresponding to the thermal image.

In another embodiment, edge extraction is performed on the first image captured by the first lens to obtain a first edge-extracted image, morphological processing is performed on the first edge-extracted image to reduce secondary features in the first edge-extracted image and thereafter to obtain a first edge image corresponding to the first image. For example, edge-extraction is performed on the thermal image via edge detection algorithm to obtain the first edge-extracted image. Some secondary features are still present in the first edge-extracted image, including images of small objects and areas with unclear boundaries or edges. To reduce these secondary features in the image, morphological processing may be performed on the first edge-extracted image to remove these secondary features and to maintain the primary or main features, and thereafter to obtain the first edge image corresponding to the thermal image.

The step of performing edge extraction on the first image captured by the first lens includes: converting the first image captured by the first lens into a greyscale image; and performing edge extraction on the greyscale image.

Images directed to by the edge detection algorithm are generally greyscale images. Accordingly, prior to performing edge extraction via edge detection algorithm, the thermal images are converted to greyscale images, greyscale images are subjected to image filtering, and then edge extraction is performed on the filtered greyscale images corresponding to the thermal image.

At step S202, the first contour information of the first image is determined according to the first edge image of the first image.

The step of determining the first contour information of the first image according to the first edge image of the first image includes: filtering the edge information of the at least one connected area of the edge image corresponding to the first image to obtain an outer contour of the at least first connected area.

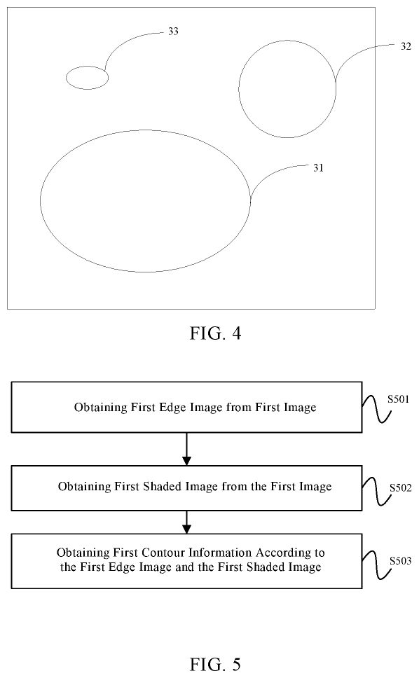

The edge image corresponding to the thermal image includes edge information, where the edge defines a border of a not-to-be-used area, and edges may connect to from the contour. As illustratively depicted in FIG. 3, reference numeral 30 represents an edge image corresponding to the thermal image, and the edge image 30 includes connected areas 31, 32, and 33, and the connected areas 31, 32, and 33 each include a portion of edge information. The image processing device may filter out the edge information of the edge image 30, for example, may filter out edge information inside of the connected areas 31, 32, and 33, to obtain outer contours of the connected areas 31, 32, and 33, as illustratively depicted in FIG. 4. Embodiments of the present disclosure are described in view of, but are not limited to, the thermal image, the edge image of the thermal image, or the edge information and the connected areas in the edge image.

Edge information may be obtained via image processing on the thermal image, contour information of the thermal image may be obtained according to the edge image, and extraction of the edge information may then be performed on the thermal image.

FIG. 5 is a schematic flow chart diagram of an image processing method. As illustratively depicted in FIG. 5, and further in view of FIG. 1, step S101 refers to obtaining the contour information of the first image captured by the first lens and may include the following step(s).

At step S501, image processing is performed on the first image captured by the first lens to obtain the first edge image of the first image.

Step S501 and step S201 are consistent with each other both in theory and operation.

For example, the edge image of the thermal image is represented by reference numeral 30 in FIG. 3.

At step S502, the first shaded image corresponding to the first image captured by the first lens is obtained via image shading algorithm, where the first shaded image includes at least one shaded target area.

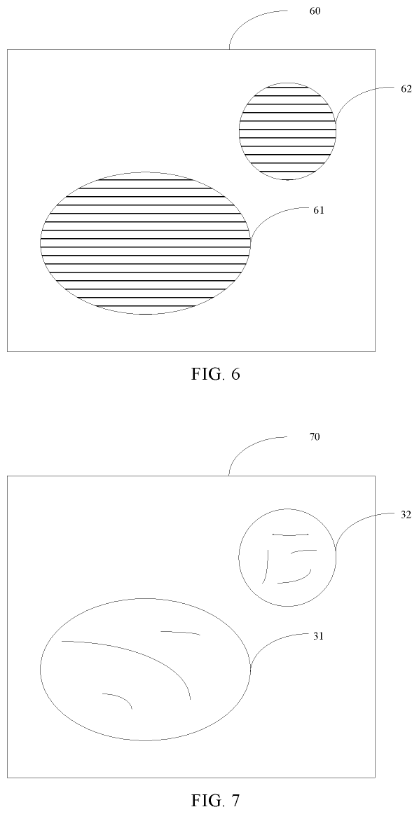

The image processing device performs shading on the thermal image captured by the thermal lens, to obtain shaded image via for example image shading algorithm. As illustratively depicted in FIG. 6, the shaded image 60 corresponds to the thermal image, and the shaded image 60 increase shaded target areas 61 and 62.

At step S503, the contour information of the first image is obtained according to the edge image and the shaded image corresponding to the first image.

The image processing device determines the contour information of the thermal image according to the edge image 30 depicted in FIG. 3 and the shaded image 60 depicted in FIG. 6.

The step of determining the contour information of the first image according to the edge image and the shaded image corresponding to the first image includes: determining at least one first connected area corresponding to the at least one shaded target area in the edge image, according to the edge image and the at least one shaded target area; filtering out edge information from the at least one first connected area to obtain first outer contour of the at least one first connected area.

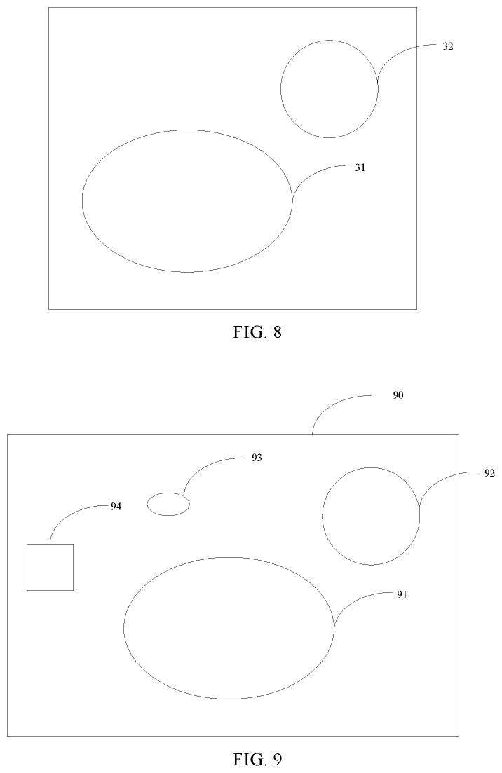

According to the edge image 30 and the shaded image 60 corresponding to the thermal image, the image processing device determines that the connected area 31 of the edge image 30 corresponds to the target area 61 of the shaded image 60, that the connected area 32 of the edge image 30 corresponds to the target area 62 of the shaded area 60, and that the connected area 33 of the edge image 30 is a non-shaded area. The non-shaded area 33 may be filtered out or removed from the edge image 30 to obtain a filtered edge image 70 as illustratively depicted in FIG. 7. Furthermore, edge information of the connected areas 31 and 32 of the edge image 70 may further be filtered out or removed to obtain the outer contours of the connected areas 31 and 32 illustratively depicted in FIG. 8.

Filtering out edge information inside of the connected areas helps provide the outer contour information. Areas inside of the outer contours of a thermal image are in general similar in temperature such that edge information in the inner areas is not very significant. To obtain satisfactory alignment between two lighting images, such as a thermal image and a visible light image.

According to embodiment(s) of the present disclosure, the edge image is extracted from the thermal image, the shaded image is obtained via image shading algorithm, contour information of the thermal image is obtained according to the edge image and the shaded image of the thermal image, and the contour information may be obtained from the thermal image with improved reliability.

The field of view of the visible light image covers over or is bigger in all-around size to the field of view of the thermal image; accordingly, the visible light image may be bigger in size than the thermal image. The image processing method performs edge extraction on the visible light image and obtains an outer contour of a connected area of the visible light image. In this embodiment, an outer contour of the connected area in the thermal image may be termed an outer contour of a first connected area, and an outer contour of the connected area in the visible light image may be termed an outer contour of a second connected area. Method for extracting an outer contour of the connected area in the visible light image may be of any suitable method and therefore is not necessarily limited. As illustratively depicted in FIG. 9, reference numeral 90 represents the visible light image, and reference numerals 91, 92, 93, and 94 represent outer contours of the connected areas in the visible light image.

In view of FIG. 2 and FIG. 5, and at step S102, the first contour information of the first image is aligned with the second contour information of the second image. In particular, an outer contour of a first connected area is aligned with an outer contour of a second connected area of the edge image of the second image. As illustratively depicted in FIG. 8, outer contours of the connected areas 31 and 32 are outer contours of the connected areas of the thermal image. The contour information of the visible light image and the contour information of the thermal image may be aligned via an alignment of the outer contours of the connected areas 31 and 32 with the outer contours of the connected areas 91, 92, 93, and 94 illustratively depicted in FIG. 9. One of the outer contours of the connected areas 91, 92, 93, and 94 may be determined to be in best alignment with the outer contour of the connected area 31. Likewise, another one of the outer contours of the connected areas 91, 92, 93, and 94 may be determined to be in best alignment with the outer contour of the connected area 32.

An outer contour of the first connected area is aligned with an outer contour of the second connected area. In particular, a target contour is selected out from the outer contours of the first connected areas, an outer contour is selected from the outer contours of the second connected areas as in best alignment with the target contour and thereafter is termed an aligning contour, and the target contour and the aligning tour are in an one-on-one correlation.

An outer contour of the connected area 31 may be determined as a target contour. An outer contour from the outer contours of the connected areas 91, 92, 93, and 94 may be determined as in best alignment with the target contour corresponding to the connected area 31. Accordingly, the outer contour that is in best alignment with the target contour is recorded as an aligning contour. For example, the outer contour of the connected area 91 is an aligning contour corresponding to the outer contour of the connected area 31. Accordingly, target contours and aligning contours may be aligned to one another with a one-on-one correlation.

An outer contour of the connected area 32 may be determined as a target contour. An outer contour from the outer contours of the connected areas 91, 92, 93, and 94 may be determined as in best alignment with the target contour corresponding to the connected area 32. Accordingly, the outer contour that is in best alignment with the target contour is recorded as an aligning contour. For example, the outer contour of the connected area 92 is an aligning contour corresponding to the outer contour of the connected area 32. Accordingly, target contours and aligning contours may be aligned to one another with a one-on-one correlation.

A number of the at least one target contour is smaller than a number of the outer contours of the at least one second connected area. For example, a number of the outer contours of the connected areas in the thermal image is smaller than a number of the outer contours of the connected areas in the visible light image. As illustratively depicted in FIG. 8, the target contour may be the outer contour of the connected area 31 and the outer contour of the connected area 32, where a number of the target contours is smaller than a number of the outer contours of the connected areas in the visible light image depicted in FIG. 9. The image processing device seeks an outer contour from the outer contours of the connected areas in the visible light image that aligns with an outer contour of the connected area in the thermal image. Accordingly, when the number of the outer contours of the connected areas in the thermal image is smaller than the number of the outer contours of the connected areas in the visible light image, the image processing device may perform the alignment with relatively greater efficiencies.

A number of the outer contours of the connected areas of the thermal image is smaller than a number of the outer contours of the connected areas of the visible light image, and accordingly, alignment may be performed by the image processing device with enhanced efficiencies.

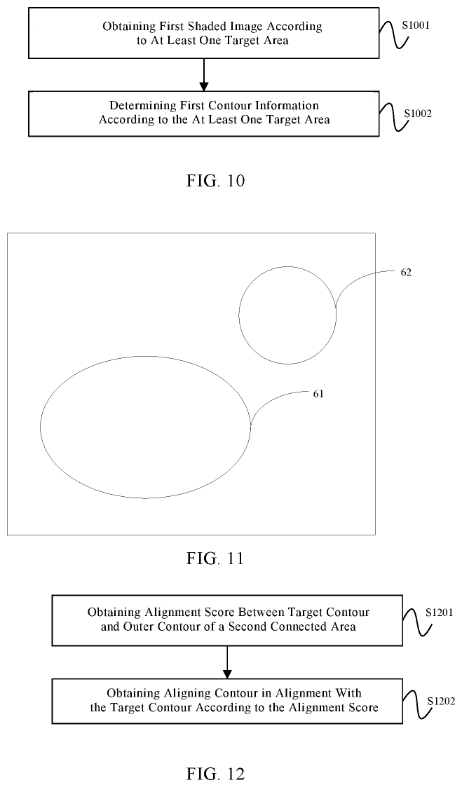

FIG. 10 is a schematic flow chart diagram of an image processing method. As illustratively depicted in FIG. 10, and further in view of FIG. 1, step S101 of obtaining the first contour information of the first image captured by the first lens may include the following step(s).

At step S1001, shaded image is obtained from the first image via image shading algorithm, and the shaded image includes at least one target area.

Step S1001 is generally similar to step S502 both in theory and operation. As illustratively depicted in FIG. 6, shaded image 60 corresponds to the thermal image, and the shaded image 60 includes target areas 61 and 62.

At step S1002, the contour information of the first image is obtained according to at least one target area of the shaded first image.

In particular, the step of obtaining the contour information of the first image according to the at least one target area of the shaded image includes: filtering out pixels from inside of the at least one target area of the shaded image to obtain the outer contour of the at least one target area.

In view of FIG. 6, pixels inside of the target areas 61 and 62 of the shaded image 60 are filtered out or removed to obtain outer contours of the target areas 61 and 62 as illustratively depicted in FIG. 11.

At step S102, the first contour information of the first image is aligned with the second contour information of the second image. In particular, an outer contour of a shaded target area is aligned with an outer contour of the second connected area in the edge image of the second image.

Contour information of visible light images is aligned to contour information of the thermal/infrared images. Outer contour of the target area 61 and outer contour of the target area 62 are respectively aligned to one of the outer contours of connected areas 91, 92, 93, and 94 captured via visible imaging. One of the outer contours of the connected areas 91, 92, 93, and 94 is selected as the best alignment for the outer contour of the connected area 61, and another of the outer contours of the connected areas 91, 92, 93, and 94 is selected as the best alignment for the outer contour of the connected area 62.

An outer contour of a shaded target area is aligned with an outer contour of a second connected area in the edge image of the second image. In particular, a target contour is selected out from the outer contours of the shaded target areas, an outer contour is selected out form the outer contours of the second connected areas as in best alignment with the target control and thereafter termed an aligning contour, and the target control and the aligning contour are in an one-on-one correlation.

The outer contour of the target area 61 is selected as a target contour. One of the outer contours 91, 92, 93, and 94 is selected as being best aligned with the outer contour of the target area 61 and hence termed the aligning contour to align the outer contour of the target area 61. For example, the outer contour 91 of the outer contours 91, 92, 93, and 94 best align the outer contour of the target area 61, and therefore is the aligning contour directed to the outer contour of the target area 61.

The outer contour of the target area 62 is selected as the target contour. One of the outer contours 91, 92, 93, and 94 is selected as being best aligned with the outer contour of the target area 62 and hence termed the aligning contour to align the outer contour of the target area 62. For example, the outer contour 92 of the outer contours 91, 92, 93, and 94 best align the outer contour of the target area 62, and therefore is the aligning contour directed to the outer contour of the target area 62 in a one-on-one aligning correlation.

A number of the target contours is smaller than a number of the outer contours of the at least one second connected area. For example, a number of the outer contours of the thermal image is smaller than a number of the outer contours of the connected areas in the visible light image. As illustratively depicted in FIG. 11, the target contours may be the outer contours of the target area 61 and the target area 62, where a number of the target contours is smaller than a number of the outer contours of the connected areas in the visible light image depicted in FIG. 9. The image processing device may seek from the outer contours of the connected areas in the visible light image an outer contour that is in best alignment with the outer contour of the connected area of the thermal image. When a number of the outer contours of the connected areas of the thermal image is smaller than a number of the outer contours of the connected areas in the visible light image, image alignment by the image processing device may be carried out with greater efficiency.

A number of the outer contours of the connected areas in the thermal image is smaller than a number of the outer contours of the connected areas in the visible light image.

FIG. 12 is a schematic flow chart diagram of an image processing method. As illustratively depicted in FIG. 12, contour alignment is performed between the target contour and the outer contour of the second connected area.

At step S1201, an outer contour of the second connected area is aligned with a target contour to obtain an alignment score representing an alignment degree of the outer contour of the second connected area relative to the target contour.

As illustratively depicted in FIG. 8 and FIG. 9, the image processing device processes alignment between the outer contours of the connected areas 91, 92, 93, and 94 relative to the outer contour of the connected area 31, to obtain alignment scores L1, L2, L3, and L4, respectively, where alignment score L1 represents an alignment degree between the connected area 91 relative to the connected area 31, alignment score L2 represents an alignment degree between the connected area 92 relative to the connected area 31, alignment score L3 represents an alignment degree between the connected area 93 relative to the connected area 31, and alignment score L4 represents an alignment degree between the connected area 94 relative to the connected area 31.

Similarly, the image processing device processes alignment between the outer contours of the connected areas 91, 92, 93, and 94 relative to the outer contour of the connected area 32, to obtain alignment scores H1, H2, H3, and H4, respectively, where alignment score H1 represents an alignment degree between the connected area 91 relative to the connected area 32, alignment score H2 represents an alignment degree between the connected area 92 relative to the connected area 32, alignment score H3 represents an alignment degree between the connected area 93 relative to the connected area 32, and alignment score H4 represents an alignment degree between the connected area 94 relative to the connected area 32.

An alignment may be performed between the target contour and the outer contour of the second connected area, to obtain an alignment score representing a degree of alignment between the target contour and the outer contour of the second connected area. In particular, a contour alignment algorithm may be employed to perform alignment between the target contour and the outer contour of the second connected area, to obtain an alignment score representing a degree of alignment between the target contour and the outer contour of the second connected area.

For example, and via the employment of an outer contour alignment algorithm, the image processing device processes alignment between the outer contours of the connected areas 91, 92, 93, and 94 relative to the outer contour of the connected area 31, to obtain alignment scores L1, L2, L3, and L4, respectively.

A contour alignment algorithm may be employed to perform alignment between the target contour and the outer contour of the second connected area, to obtain an alignment score representing a degree of alignment between the target contour and the outer contour of the second connected area. In particular, an outer contour alignment algorithm may be employed to perform alignment between the target contour and the outer contour of the second connected area, to obtain an alignment score representing a degree of alignment between the target contour and the outer contour of the second connected area.

For example, and via the employment of an outer contour aligning algorithm, the image processing device processes aligning between the outer contours of the connected areas 91, 92, 93, and 94 relative to the outer contour of the connected area 31, to obtain alignment scores L1, L2, L3, and L4, respectively.

Outer contour alignment algorithm may be employed to perform alignment between the outer contour of the second connected area and the target contour, to then obtain an alignment score representing a degree of alignment between the outer contour of the second connected area and the target contour. A first outer contour alignment algorithm may be employed to perform an alignment between the outer contour of the second connected area and the target contour, to obtain a first alignment score representing a degree of alignment between the target contour and the outer contour of the second connected area. A second outer contour alignment algorithm may be employed to perform an alignment between the outer contour of the second connected area and the target contour, to obtain a second alignment score representing a degree of alignment between the target contour and the outer contour of the second connected area. According to the first and second alignment scores, an alignment score may be obtained as representing a degree of alignment between the target contour and the outer contour of the second connected area.

According to the first and second alignment scores, an alignment score may be obtained as representing a degree of alignment between the target contour and the outer contour of the second connected area. In particular, a weighted summation is performed on the first and second alignment scores, to obtain the alignment score representing a degree of alignment between the target contour and the outer contour of the second connected area.

In some embodiments, the first outer contour alignment algorithm includes Hu invariant moment algorithm.

In some embodiments, the second outer contour alignment algorithm includes contour template alignment algorithm.

For example, and via the employment of an outer contour alignment algorithm, the image processing device processes alignment between the outer contours of the connected areas 91, 92, 93, and 94 relative to the outer contour of the connected area 31, to obtain alignment scores L1, L2, L3, and L4, respectively.

In particular, and via the employment of Hu invariant moment algorithm, the image processing device processes alignment between the outer contours of the connected areas 91, 92, 93, and 94 relative to the outer contour of the connected area 31, to obtain alignment scores L11, L21, L31, and L41, respectively, where the alignment score L11 represents an alignment degree of the outer contour of the connected area 91 relative to the outer contour of the connected area 31, the alignment score L21 represents an alignment degree of the outer contour of the connected area 92 relative to the outer contour of the connected area 31, the alignment score L31 represents an alignment degree of the outer contour of the connected area 93 relative to the outer contour of the connected area 31, and the alignment score L41 represents an alignment degree of the outer contour of the connected area 94 relative to the outer contour of the connected area 31.

In particular also, and via the employment of contour template alignment algorithm, the image processing device processes alignment between the outer contours of the connected areas 91, 92, 93, and 94 relative to the outer contour of the connected area 31, to obtain alignment scores L12, L22, L32, and L42, respectively, where the alignment score L12 represents an alignment degree of the outer contour of the connected area 91 relative to the outer contour of the connected area 31, the alignment score L22 represents an alignment degree of the outer contour of the connected area 92 relative to the outer contour of the connected area 31, the alignment score L32 represents an alignment degree of the outer contour of the connected area 93 relative to the outer contour of the connected area 31, and the alignment score L42 represents an alignment degree of the outer contour of the connected area 94 relative to the outer contour of the connected area 31.

Therefore, the image processing device obtains L1 via weighted summation of L11 and L12, obtains L2 via weighted summation of L21 and L22, obtains L3 via weighted summation of L31 and L32, and obtains L4 via weighted summation of L41 and L42.

Moreover, and via the employment of the outer contour alignment algorithm, the image processing device processes alignment between the outer contours of the connected areas 91, 92, 93, and 94 relative to the outer contour of the connected area 33, to obtain alignment scores H1, H2, H3, and H4, respectively, in a manner similar to the manner via which L1, L2, L3, and L4 are obtained.

Contour alignment algorithm is not limited to Hu invariant moment algorithm, contour template alignment algorithm, and is further not limited to weighted summation on two outer contour alignment algorithms. Other outer contour alignment algorithm may be employed in calculating the alignment score.

At step S1202, and according to the alignment score, an outer contour of the second connected area may be determined to be the aligning contour for the target contour.

In some embodiments, the smaller the alignment score, the more similar the two outer contours. In some other embodiments, L1 is the smallest out of L1, L2, L3, and L4; and accordingly, the outer contour of the connected area 91 is comparatively of best alignment with the outer contour of the connected area 31, and the outer contour of the connected area 91 is the aligning contour for the outer contour of the connected area 31.

Out of H1, H2, H3, and H4, H2 is the smallest; and this means that the outer contour of the connected area 92 aligns the best relative to the outer contour of the connected area 32, and accordingly, the outer contour of the connected area 92 may be the aligning contour relative to the outer contour of the connected area 32.

Alignment is performed between the outer contour of the second connected area and the target contour, to obtain an alignment score representing a degree of alignment between the outer contour of the second connected area and the target contour. According to the alignment score, one of the outer contours of the at least one second connected area may be determined to be the aligning contour for the target contour, such that contour alignment may be carried out with enhanced accuracy.

Step S1201, where an outer contour of the second connected area is aligned to a target contour to obtain an alignment score, includes: an outer contour of the second connected area is aligned with a first target contour to obtain a first alignment score representing a first alignment degree between the outer contour relative to the first target contour, and another outer contour of the second connected area is aligned with a second target contour to obtain a second alignment score representing a second alignment degree between the another outer contour relative to the second target contour.

As illustratively depicted in FIG. 8 and FIG. 9, the outer contour of the connected area 31 is selected as a target contour, and the image processing device may then perform alignment on the outer contours of the connected areas 91, 92, 93, and 94 relative to the outer contour of the connected area 31, to obtain alignment score L1, L2, L3, and L4, where alignment score L1 represents an alignment degree of the outer contour of the connected area 91 relative to the outer contour of the connected area 31, alignment score L2 represents an alignment degree of the outer contour of the connected area 92 relative to the outer contour of the connected area 31, alignment score L3 represents an alignment degree of the outer contour of the connected area 93 relative to the outer contour of the connected area 31, and alignment score L4 represents an alignment degree of the outer contour of the connected area 94 relative to the outer contour of the connected area 31.

Similarly, the outer contour of the connected area 32 is selected as a target contour, and the image processing device may then perform alignment on the outer contours of the connected areas 91, 92, 93, and 94 relative to the outer contour of the connected area 32, to obtain alignment score H1, H2, H3, and H4, where alignment score H1 represents an alignment degree of the outer contour of the connected area 91 relative to the outer contour of the connected area 32, alignment score H2 represents an alignment degree of the outer contour of the connected area 92 relative to the outer contour of the connected area 32, alignment score H3 represents an alignment degree of the outer contour of the connected area 93 relative to the outer contour of the connected area 32, and alignment score H4 represents an alignment degree of the outer contour of the connected area 94 relative to the outer contour of the connected area 32.

At step S1202, and according to the alignment score, an aligning contour is selected from the outer contours of the second connected area, the aligning contour aligns with the target contour. In particular, according to the first alignment score, a first aligning contour is selected out from the outer contours of the second connected area, the first target contour aligns best with the first aligning contour; and according to the second alignment score, a second aligning contour is selected out from the outer contours of the second connected area, the second target contour aligns best with the second aligning contour. According to a relative position of the first and second target contours, and according to a relative position between the first and second aligning contours, it is determined as to whether the first aligning contour is the aligning contour relative to the first target contour, and whether the second aligning contour is the aligning contour relative to the second target contour.

In some embodiments, two outer contours are better aligned when their corresponding alignment score is relatively smaller. In some embodiments, and out of L1, L2, L3, and L4, L1 is the smallest, and this means the outer contour of the connected area 91 aligns the best relative to the outer contour of the connected area 31. Out of H1, H2, H3, and H4, H2 is the smallest, and this means that the outer contour of the connected area 92 aligns the best relative to the outer contour of the connected area 32.

The image processing device determines a first relative position between the outer contours of the connected areas 31 and 32 as illustratively depicted in FIG. 8, determines a second relative position between the outer contours of the connected areas 91 and 92 as illustratively depicted in FIG. 9, and determines if the first relative position between the outer contours of the connected areas 31 and 32 as illustratively depicted in FIG. 8 is in alignment with the second relative position between the outer contours of the connected areas 91 and 92 as illustratively depicted in FIG. 9. If the relative positions are determined to be in alignment, the image processing device determines that an outer contour of the connected area 91 is an aligning contour for the outer contour of the connected area 31, and an outer contour of the connected area 92 is a aligning contour for the outer contour of the connected area 32. If the relative positions are determined to not be in alignment, process of alignment continues.

According to a relative position between the first target contour and the second target contour, a relative position between the first contour and the second contour is adjusted, so as to determine whether the first contour aligns with the first target contour and whether the second contour aligns with the second target contour, such that contour alignment may be carried out with greater accuracy.

The present disclosure provides an image processing method. According to what is described herein, and at step S103, a relative position between the first and second images is adjusted according to aligning contour image between the first and second images; in particular, a relative position between the first and second images is adjusted according to the target contour and the aligning contour so as to align the target contour with the aligning contour. In view of FIG. 8 and FIG. 9, a relative position between the thermal image and the visible light image may be adjusted according to outer contours aligned between the thermal image and the visible light image. For example, according to the outer contour of the connected area 31 and the outer contour of the connected area 91 that aligns with the outer contour of the connected area 31, a relative position between the thermal image and the visible light image is adjusted, so as to align the outer contour of the connected area 31 with the outer contour of the connected area 91. For example also, according to the outer contour of the connected area 32 and the outer contour of the connected area 92 that aligns with the outer contour of the connected area 32, a relative position between the thermal image and the visible light image is adjusted, so as to align the outer contour of the connected area 32 with the outer contour of the connected area 92.

According to the target contour and the aligning contour, a relative position between the first and second images is adjusted to effectuate an alignment between the target contour and the aligning contour. This step may include the following step(s).

According to predetermined points on the target contour and the aligning contour, a relative position between the first image and second image is adjusted, so as to effectuate an alignment between the target contour and the aligning contour. The predetermined points may include the characteristic features.

For example, feature points on the outer contour of the connected area 31 and feature points on the outer contour of the connected area 91 are selected, a relative position between the thermal image and the visible light image is adjusted according to the feature points on the outer contour of the connected area 31 and feature points on the outer contour of the connected area 91, so as to align the outer contour of the connected area 31 with the outer contour of the connected area 91. Similarly, feature points on the outer contour of the connected area 32 and feature points on the outer contour of the connected area 92 are selected, a relative position between the thermal image and the visible light image is adjusted according to the feature points on the outer contour of the connected area 32 and feature points on the outer contour of the connected area 92, so as to align the outer contour of the connected area 32 with the outer contour of the connected area 92.

Alternatively, a centroid of the target contour and a centroid of the aligning contour are determined; and a relative position between the first image and the second image is adjusted according to the centroid of the target contour and the centroid of the aligning contour, to effectuate an alignment between the target contour and the aligning contour.

For example, the centroid of the connected area 31 and the centroid of the connected area 91 are determined, and a relative position between the connected area 31 and the connected area 91 is adjusted according to the centroid of the connected area 31 and the centroid of the connected area 91, to then effectuate an alignment between the outer contour of the connected area 31 and the outer contour of the connected area 91. Likewise, the centroid of the connected area 32 and the centroid of the connected area 92 are determined, and a relative position between the connected area 32 and the connected area 92 is adjusted according to the centroid of the connected area 32 and the centroid of the connected area 92, to then effectuate an alignment between the outer contour of the connected area 32 and the outer contour of the connected area 92.

Another suitable method may include the following step(s).

At step one, the centroid of the target contour and the centroid of the aligning contour are determined.

At step two, and according to the centroid of the target contour, the centroid of the aligning contour, and the size of the first image, the second image is adjusted in its size such that the first and second images are the same in size.

At step three, and according to the centroid of the target contour and the centroid of the aligning contour, and a relative position between the first image and the second image is adjusted, where the second image has previously been adjusted in its size, so as to effectuate an alignment between the target contour and the aligning contour.

Yet another suitable method may include the following step(s).

At step one, the centroid of the target contour and the centroid of the aligning contour are obtained or determined.

At step two, and according to the centroid of the target contour and the centroid of the aligning contour, a relative position between the first and second images is adjusted, so as to align the target contour with the aligning contour.

At step three, and according to the centroid of the target contour, the centroid of the aligning contour, and the size of the first image, the size of the second image is adjusted such that the first and second images are of the same size.

According to predetermined points on the target contour and on the alignment contour, a relative position between the first and second images is adjusted to align the target contour with the aligning contour. Alternatively, and according to a centroid of the target contour and a centroid of the aligning contour, a relative position between the first and second images is adjusted to align the target contour with the aligning contour, and alignment between the target contour and the aligning contour is thus provided with enhanced flexibility. Moreover, and with the automatic image alignment, relative position between images can be carried out without necessarily requiring manual adjustment, and image processing is thus provided with enhanced efficiency.

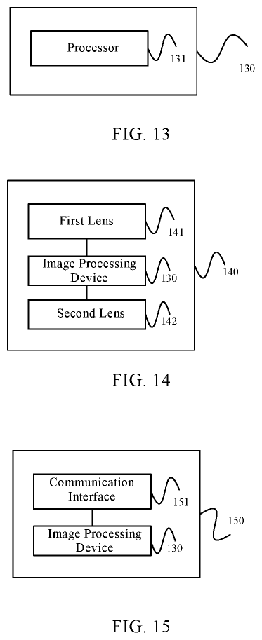

The present disclosure also provides an image processing device. As illustratively depicted in FIG. 13, the image processing device includes a processor 131. The processor 131 is configured to: obtaining the first contour information of the first image captured by the first lens and the second contour information of the second image captured by the second lens, the first and second images being captured at the same time; performing alignment between the first contour information of the first image and the second contour information of the second image to obtain aligning contour information between the first and second images. The processor is further configured to perform: adjusting a relative position between the first and second images according to the aligning contour information of the first and second images, to obtain a fused image of the first and second images via fusing the first and second images, the fused image including edge information of the first and second images.

In some embodiments, the first lens includes a thermal imaging lens and the second lens includes a visible light lens.

In some embodiments, a second field of view of the second lens covers over or overlays a first field of view of the first lens.

In some embodiments, a second focal length of the second lens is smaller than a first focal length of the first lens.

In some embodiments, the second lens is positioned on a lens carrier, where the first lens is connected to the lens carrier via a flexible component.

In some embodiments, the first lens is positioned on a lens carrier, where the second lens is connected to the lens carrier via a flexible component.

In some embodiments, the first and second lenses are each connected to the lens carrier via a flexible component.

In some embodiments, a center of the first lens and a center of the second lens are on the same horizontal line.

In some embodiments, the first lens is not present in a field of vision of the second lens, and the second lens is not present in a field of vision of the first lens.

In some embodiments, the processor 131 obtains the first contour information of the first image captured by the first lens; in particular, the processor 131 performs image processing on the first image captured by the first lens to obtain first edge image of the first image, and then obtains first contour information of the first image according to the first edge information of the first image.

In some embodiments, the processor 131 performs image processing on the first image captured by the first lens to obtain the first edge image of the first image; in particular, the processor 131 performs edge extraction on the first image captured by the first lens to obtain the first edge image of the first image.

In some embodiments, the processor 131 performs image processing on the first image captured by the first lens to obtain the first edge image of the first image; in particular, the processor 131 performs edge extraction on the first image captured by the first lens to obtain a first edge-extracted image, then performs morphological processing on the first edge-extracted image to reduce secondary features in the first edge-extracted image and thereafter to obtain the first edge image corresponding to the first image.

In some embodiments, the processor 131 performs edge extraction on the first image captured by the first lens; in particular, the processor 131 converts the first image into a greyscale image and then performs edge extraction on the greyscale image.

In some embodiments, the processor 131 determines the first contour information according to the first edge image of the first image; in particular, the processor 131 filters out edge information inside of at least one first connected area of the edge image of the first image to obtain an outer contour of the first connected area.

In some embodiments, the processor 131 performs image processing on the first image captured by the first lens to obtain the first edge image of the first image, and also performs image shading/highlighting/augmentation/shading on the first image to obtain shaded or augmented first image, wherein the shaded first image includes at least one shaded target area. Accordingly, the processor determines the first contour information of the first image according to the first edge image of the first image; in particular, the processor 131 obtains the first contour information of the first image according to the first edge image and the first shaded image of the first image.

In some embodiments, the processor 131 determines the first contour information of the first image according to the first edge image and the first shaded image of the first image; in particular, the processor 131 determines a first connected area out from the first edge image according to the first edge image and a target area of the shaded image, where the first connected area corresponds to the target area of the shaded image, and the processor 131 filters out edge information from the first connected area to obtain the outer contour of the first connected area.

In some embodiments, the processor 131 performs alignment of the first contour information of the first image relative to the second contour information of the second image; in particular, the processor 131 performs alignment of an outer contour of the first connected area relative to an outer contour of the second connected area of the second edge image of the second image.

In some embodiments, the processor 131 performs alignment on an outer contour of the second connected area of the edge image of the second image relative to an outer contour of the first connected area; in particular, the processor 131 selects a target contour from the outer contours of the first connected area, selects an aligning contour from the outer contours of the second connected area, where the aligning contour aligns with the target contour in a one-on-one alignment correlation.

In some embodiments, the processor 131 obtains the first contour information of the first image captured by the first lens.

Image shading algorithm processing is performed on the first image to obtain the first shaded image, the first shaded image includes at least one shaded target area, and the first contour information of the first image is obtained according to the at least one shaded target area of the shaded image.

In some embodiments, the processor 131 determines the first contour information of the first image according to the at least one target area of the shaded image; in particular, pixels are filtered out of the target area of the shaded image to obtain an outer contour of the target area of the shaded image.

In some embodiments, the processor performs alignment on the contour information of the first image relative to the contour information of the second image; in particular, the processor 131 performs alignment on the outer contour of the second connected area of the edge image of the second image relative to the outer contour of the target area of the shaded image.

In some embodiments, the processor 131 performs alignment on an outer contour of the second connected area in the edge image of the second image relative to an outer contour of a target area of the shaded image; in particular, the processor 131 selects a target contour out from the outer contours of the target area of the shaded image, selects an aligning contour from the outer contours of the second connected area, where the aligning contour aligns with the target contour in an one-one-one alignment correlation.

In some embodiments, a number of the at least one target contour is smaller than a number of the at least one outer contour of the second connected area.

In some embodiments, the processor 131 performs alignment on an outer contour of the second connected area relative to a target contour; in particular, the processor 131 performs alignment on an outer contour of the second connected area relative to a target contour to obtain an alignment score, which represents an alignment degree between the outer contour of the second connected area and the target contour, and then selects an aligning contour from the outer contours of the connected area according to the alignment score.

In some embodiments, the processor 131 performs alignment on an outer contour of the second connected area relative to a target contour to obtain an alignment score; in particular, the processor 131 performs alignment on an outer contour of the second connected area relative to a target contour to obtain an alignment score, via at least one contour alignment algorithm.

In some embodiments, the processor 131 aligns the target contour with an outer contour of the second connected area via a contour alignment algorithm to obtain an alignment score representing a degree of alignment between the target contour and the outer contour of the second connected area. In particular, the processor 131 aligns the target contour with an outer contour of the second connected area via an outer contour alignment algorithm to obtain an alignment score representing a degree of alignment between the target contour and the outer contour of the second connected area.

In some embodiments, the processor 131 aligns the target contour with the outer contour of the second connected area via outer contour alignment algorithm to obtain an alignment score representing a degree of alignment between the outer contour of the second connected area and the target contour. In particular, and according to a first outer contour alignment algorithm, the target contour is aligned with the outer control of the second connected area to obtain a first alignment score between the target contour and the outer contour of the second connected area. In particular also, and according to a second outer contour alignment algorithm, the target contour is aligned with the outer control of the second connected area to obtain a second alignment score between the target contour and the outer contour of the second connected area. According to the first and second alignment scores, an alignment score is obtained to represent a degree of alignment between the outer contour of the second connected area and the target contour.

In some embodiments, the processor 131 obtains an alignment score representing a degree of alignment between the outer contour of the second connected area and the target contour, according to the first and second alignment scores; in particular, a weighted summation is obtained on the first and second alignment scores to obtain the alignment score representing the degree of alignment between the outer contour of the second connected area and the target contour.

In some embodiments, the first contour alignment algorithm includes Hu invariant moment algorithm.

In some embodiments, the second contour alignment algorithm may include contour template alignment algorithm.

In some embodiments, the processor 131 performs alignment on the outer contour of the second connected area relative to the target contour, to obtain an alignment score representing an alignment degree between the outer contour of the second connected area and the target contour. In particular, an outer contour of the second connected area is aligned with a first target contour to obtain a first alignment score representing a first alignment degree between the outer contour relative to the first target contour, another outer contour of the second connected area is aligned with a second target contour to obtain a second alignment score representing a second alignment degree between the another outer contour relative to the second target contour.

From the outer contours of the second connected area, the processor 131 selects an aligning contour that aligns with the target contour. In particular, and according to a first alignment score, a first aligning contour is selected from the outer contours of the second connected areas, where the first aligning contour aligns with the first target contour with the highest degree of alignment; according to a second alignment score, a second alignment contour is selected from the outer contours of the second connected areas, where the second aligning contour aligns with the second target contour with the highest degree of alignment and according to a relative position between the first and second target contours, and according to a relative position between first and second aligning contours, it is determined as to whether the first aligning contour is a best alignment fit for the first target contour and whether the second aligning contour is a best alignment fit for the second target contour.

In some embodiments, the processor 131 adjusts a relative position between the first and second images according to the aligning contour information between the first and second images; in particular, and according to the target contour and the aligning contour, the relative position between the first and second images is adjusted so as to align the target contour with the aligning contour.

In some embodiments, the processor 131 adjusts a relative position between the first image and the second image according to the target contour and the aligning contour, to align the target contour with the aligning contour. In particular, and according to predetermined points on the target contour and on the aligning contour, the relative position between the first image and the second image is adjusted, to then have the target contour aligned with the aligning contour.

In some embodiments, the predetermined points include the characteristic features.

In some embodiments, the processor 131 adjusts a relative position between the first and second images according to the target contour and the aligning contour, to align the target contour with the aligning contour; in particular, a centroid of the target contour and a centroid of the aligning contour are determined; according to the centroid of the target contour and the centroid of the aligning contour, the relative position between the first and second images is adjusted, so as to align the target contour with the aligning contour.

In some embodiments, the processor 131 determines the centroid of the target contour and the centroid of the aligning contour; and thereafter, and according to the centroid of the target contour, the centroid of the aligning contour, and the size of the first image, the second image is adjusted in size such that the first and second images are of the same size.

The processor 131 adjusts a relative position between the first and second images according to the centroid of the target contour and the centroid of the aligning contour; in particular, and according to the centroid of the target contour and the centroid of the aligning contour, the relative position between the first and second images is adjusted.

In some embodiments, the processor 131 adjusts a relative position between the first and second images according to the centroid of the target contour and the centroid of the aligning contour; in particular, and according to the centroid of the target contour, the centroid of the aligning contour, and the size of the first image, the second image is adjusted in size such that the first and second images are of the same size.

In some embodiments, the processor 131 performs image fusion between the first and second images to obtain a fused image, and the fused image includes edge information of the first and second images; in particular, and according to a strength value of the edge information represented by a predetermined parameter, the edge information of the second image is overlaid onto the first image to obtain the fused image.

The image processing device may be similarly practiced according to the image processing method described herein, both in theory and in operation.

The first contour information is obtained from the first image captured by the first lens, the second contour information is obtained from the second image captured by the second image, the first and second images are captured at the same time, the first contour information of the first image is aligned with the second contour information of the second image to obtain aligning contour information between the first and second images. Via adjusting a relative position between the first and second images according to the aligning contour information, the first image is fused with the second image to obtain a fused image. In so doing, the fused image may be created without necessarily having to extract characteristic features of the first and second images, and therefore quality problems otherwise associated with feature extractions may be avoided.

The present disclosure also provides an imaging device. FIG. 14 is a schematic structural diagram of an imaging device. As depicted in FIG. 14, the imaging device 140 includes a first lens 141, a second lens 142, an image processing device 130 as described herein, the image processing device 130 processes images captures by the first lens 141 and the second lens 142.

The image processing device 130 is similar to the image processing device described herein both in theory and operation.

The present disclosure also provides a ground station device. FIG. 15 is a schematic structural diagram of a ground station device. As illustratively depicted in FIG. 15, the ground station device 150 includes a communication input 151, an image processing device 130 as described herein, where the communication interface 151 is to receive images sent from the unmanned aerial vehicle, including the first image captured by the first lens and the second image captured by the second lens, and the first and second lenses are positioned on the unmanned aerial vehicle.

The image processing device 130 is similar to the image processing device described herein both in theory and operation.

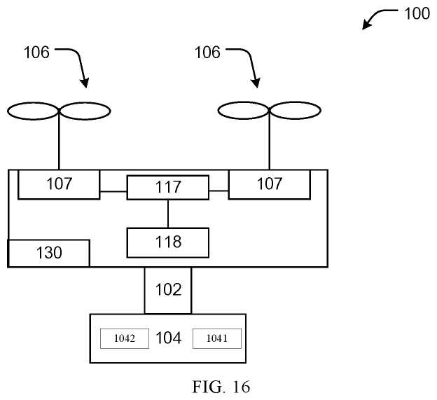

The present disclosure also provides an unmanned aerial vehicle. FIG. 16 is a schematic structural diagram of an unmanned aerial vehicle. As illustratively depicted in FIG. 16, the unmanned aerial vehicle 100 includes a vehicle body, a power system, a flight controller 118, an imaging device 104, and an image processing device 130 as described herein.

The power system may include an electric motor 107, a propeller 106, and an electric speed adjuster 117. The power system may be installed on the vehicle body to provide flight power.

The flight controller 118 may be connected to the power system to control flight of the unmanned aerial vehicle.

The imaging device 104 includes a first lens 1041 and a second lens 1042. The imaging device 104 is supported on the vehicle body via a support component 102. The support component 102 may be a gimbal.

The image processing device 130 is similar to the image processing device described herein both in theory and operation.

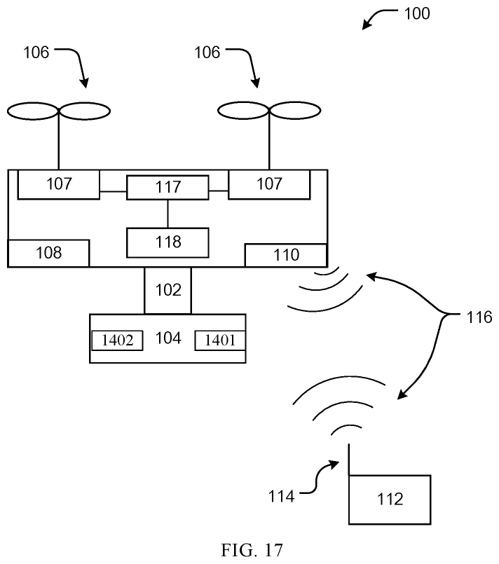

As illustratively depicted in FIG. 17, the unmanned aerial vehicle 100 includes a sensor system 108, a communication system 110, where the communication system 110 includes a receiver to receive wireless signals sent by the antenna 114 from the ground station device 112. Reference numeral 116 represents electromagnetic wave generated during communication between the receiver and the antenna 114. The communication system 110 also sends to the ground station device 112 images from the imaging device 104, including the first image captured by the first lens 1041 and the second image captured by the second lens 1042.

The integrated unit implemented in the form of a software functional unit may be stored in a computer-readable storage medium. The integrated unit may include one or more instructions, when executed, for performing steps mentioned herein via the employment of a computing device (such as a personal computer, a server, or a network device) or a processor. The storage medium may include a U-disk, mobile hard disk, Read-Only Memory (ROM), Random Access Memory (RAM), or any other disk or disc suitable as storage medium for computing code.

Devices, systems, programs, and methods in actions, orders, steps, and periods, as referenced to in the present disclosure, the claims, and the drawings, may be in any suitable order. In particular, terms such as “first” and “next” may be used to simplify the task of description, but not to imply that such order is necessary.

The present disclosure is described in view of the embodiments but the embodiments as described do not necessarily limit the scope of any of the claims. Certain embodiments or features of the embodiments described herein may be combined; however, not all such combinations are necessarily required for the solutions to the disclosure. To those skilled in the technical art, many suitable changes and improvements may be made to the embodiments. Such suitable changes and improvements are understood to be included in the scope defined by the claims.

What is claimed is:

1. An image processing method, comprising:
obtaining first contour information of a first image captured by a first lens and second contour information of a second image captured by a second lens, the first and second images being captured at the same time;
aligning the first contour information of the first image with the second contour information of the second image to obtain aligning contour information of the first and second contour information; and
adjusting a relative position between the first and second images according to the aligning contour information to fuse the first and second images to obtain a fused image, the fused image including first edge information of the first image and second edge information of the second image.

2. The method of claim 1, wherein the first lens includes a thermal imaging lens, and the second lens includes visible light lens.

3. The method of claim 1, wherein a second field of view of the second lens covers over a first field of view of the first lens.

4. The method of claim 1, wherein a second focal length of the second lens is smaller than a first focal length of the first lens.

5. The method of claim 1, wherein obtaining the first contour information of the first lens includes:
obtaining a first edge image of the first image; and
obtaining the first contour information according to the first edge image.

6. The method of claim 5, wherein obtaining the first edge image of the first image includes: performing edge extraction on the first image to obtain the first edge image.

7. The method of claim 5, wherein obtaining the first edge image of the first lens includes:
performing edge extraction on the first image to obtain edge-extracted first image; and
removing secondary features from the edge-extracted first image via morphological processing to obtain the first edge image of the first image.

8. The method of claim 6, wherein performing edge extraction on the first image to obtain the first edge image includes:
converting the first image into a first greyscale image; and
performing edge extraction on the first greyscale image.

9. The method of claim 1, wherein obtaining the first contour information of the first image includes:
obtaining a first shaded image of the first image via image shading algorithm, the first shaded image including a first target area; and
obtaining the first contour information according to the first target area.

10. The method of claim 9, wherein obtaining the first contour information according to the first target area includes:
filtering out pixels inside of the first target area to obtain a first contour of the first target area.

11. The method of claim 10, wherein aligning the first contour information of the first image with the second contour information of the second image includes:
obtaining a second contour of a second connected area of the second edge image of the second image; and
aligning the first contour of the first target area with the second contour of the second connected area.

12. The method of claim 11, wherein the first contour includes a plurality of first contours and the second contour includes a plurality of second contours, and wherein aligning the first contour of the first target area with the second contour of the second connected area includes:
selecting a first target contour from the plurality of first contours; and
selecting a second aligning contour from the plurality of second contours, the second aligning contour aligning the first target contour.

13. An image processing device, comprising a processor configured to perform:
obtaining first contour information of a first image captured by a first lens and second contour information of a second image captured by a second lens, the first and second images being captured at the same time;
aligning the first contour information of the first image with the second contour information of the second image to obtain aligning contour information of the first and second contour information; and
adjusting a relative position between the first and second images according to the aligning contour information to fuse the first and second images to obtain a fused image, the fused image including first edge information of the first image and second edge information of the second image.

14. The image processing device of claim 13, wherein the first lens includes a thermal imaging lens, and the second lens includes visible light lens.

15. The image processing device of claim 13, wherein a second field of view of the second lens covers over a first field of view of the first lens.

16. The image processing device of claim 15, wherein a second focal length of the second lens is smaller than a first focal length of the first lens.

17. The image processing device of claim 13, wherein obtaining the first contour information of the first lens includes:
obtaining a first edge image of the first image; and
obtaining the first contour information according to the first edge image.

18. The image processing device of claim 17, wherein obtaining the first edge image of the first image includes: performing edge extraction on the first image to obtain the first edge image.

19. The image processing device of claim 17, wherein obtaining the first edge image of the first lens includes:
performing edge extraction on the first image to obtain edge-extracted first image; and
removing secondary features from the edge-extracted first image via morphological processing to obtain the first edge image of the first image.

20. The image processing device of claim 18, wherein performing edge extraction on the first image to obtain the first edge image includes:
converting the first image into a first greyscale image; and
performing edge extraction on the first greyscale image.

21. The image processing device of claim 13, wherein obtaining the first contour information of the first image includes:
obtaining a first shaded image of the first image via image shading algorithm, the first shaded image including a first target area; and
obtaining the first contour information according to the first target area.

22. The image processing device of claim 21, wherein obtaining the first contour information according to the first target area includes:
filtering out pixels inside of the first target area to obtain a first contour of the first target area.

23. The image processing device of claim 22, wherein aligning the first contour information of the first image with the second contour information of the second image includes:
obtaining a second contour of a second connected area of the second edge image of the second image; and
aligning the first contour of the first target area with the second contour of the second connected area.

24. The image processing device of claim 23, wherein the first contour includes a plurality of first contours and the second contour includes a plurality of second contours, and wherein aligning the first contour of the first target area with the second contour of the second connected area includes:
selecting a first target contour from the plurality of first contours; and
selecting a second aligning contour from the plurality of second contours, the second aligning contour aligning the first target contour.

25. An imaging device, comprising: first and second lens; and an image processing device including a processor, the processor being configured to perform:
obtaining first contour information of a first image captured by the first lens and second contour information of a second image captured by the second lens, the first and second images being captured at the same time;
aligning the first contour information of the first image with the second contour information of the second image to obtain aligning contour information of the first and second contour information; and
adjusting a relative position between the first and second images according to the aligning contour information to fuse the first and second images to obtain a fused image, the fused image including first edge information of the first image and second edge information of the second image.
